(19) United States
(12) Patent Application Publication
(10) Pub. No.: US 2023/0350688 A1
(43) Pub. Date: Nov. 2, 2023

(54) VECTOR INSTRUCTION WITH PRECISE INTERRUPTS AND/OR OVERWRITES

(71) Applicant: Optimum Semiconductor Technologies Inc., Tarrytown, NY (US)

(72) Inventors: Mayan MOUDGILL, Chappaqua, NY (US); John GLOSSNER, Nashua, NH (US)

(73) Assignee: Optimum Semiconductor Technologies Inc., Tarrytown, NY (US)

(21) Appl. No.: 18/350,729

(22) Filed: Jul. 11, 2023

Related U.S. Application Data
(62) Division of application No. 17/266,338, filed on Feb. 5, 2021.
(60) Provisional application No. 62/718,426, filed on Aug. 14, 2018.

(51) Int. Cl. G06F 9/38; G06F 9/30

(52) U.S. Cl. CPC G06F 9/3857; G06F 9/30101; G06F 9/3861; G06F 9/3869

(57) ABSTRACT

A processor includes a vector register file including vector registers, at least one buffer register, and a vector processing core to receive a vector instruction comprising a first identifier representing a first vector register of the vector registers, and a second identifier representing a second vector register of the vector registers, wherein the first vector register is a source register and the second vector register is a destination register, execute the vector instruction based on data values stored in the first vector register to generate a result and store the result in the at least one buffer register, and copy the result from the at least one buffer register to the second vector register.

### CROSS-REFERENCE TO RELATED APPLICATION

This application is a divisional application of U.S. Application 17/266,338 filed Feb. 5, 2021, which is the U.S. national stage of PCT/US2019/046275 filed Aug. 13, 2019, which claims priority benefit to U.S. Provisional Application 62/718,426 filed Aug. 14, 2018. The contents of the above-mentioned applications are incorporated by reference in their entireties.

### 0002 TECHNICAL FIELD

The present disclosure relates to computer processors, and in particular, to processors that support vector instructions with precise interrupts and/or overwrites.

### BACKGROUND

A vector processor (also known as array processor) is a hardware processing device (e.g., a central processing unit (CPU) or a graphic processing unit (GPU)) that implements an instruction set architecture (ISA) containing vector instructions operating on vectors of data elements. A vector is a one-directional array containing ordered scalar data elements. As a comparison, a scalar instruction operates on singular data elements. By operating on vectors containing multiple data elements, vector processors may achieve significant performance improvements over scalar processors that supports scalar instructions operating on singular data elements.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a hardware processor according to an implementation of the present disclosure.

FIG. 2 illustrates an exemplary implementation of a vector instruction using buffer registers according to an implementation of the disclosure.

### DETAILED DESCRIPTION

A vector instruction implemented to be executed by a hardware processor is an instruction that performs operations on vectors containing more than one elements of a certain data type. The input and output data are stored in one or more vector registers associated with the processor. These vector registers are storage units that are designed to hold the multiple data elements of the vectors. Exemplary vector instructions include the streaming single instruction multiple data extension (SSE) instructions specified in the x86 instruction set architecture (ISA). Some implementations of ISA may support variable length vector instructions. A variable length vector instruction includes a register identifier that specifies a register storing the number of elements of a vector to be operated on by the instruction. The register in the variable length vector instruction is called vector-length register.

Although vector instructions can significantly improve the processor performance, vector instructions may potentially suffer the write-after-read data hazards. The write-after-read data hazard is explained using the following example. As an example, consider an instruction set architecture that specifies eight (8) vector registers identified by $v0 to $v7 in instructions. Each of these vector registers is capable of holding 32-byte worth of data. These 32 bytes can be used in different ways to hold different data types. For example, the elements of the 32-byte vector register interpreted as:
16 16-bit integers (halfword), or
8 32-bit integers (word), or
8 32-bit floating point single precision numbers, or
combinations of other data types such as 8-bit integer, 64-bit integer, 16-bit floating point, or 64-bit floating point

Different data types of the elements may be represented using a suffix on a vector register. For example, “_h,” “_w,” and “_f” may be used to indicate that the data elements stored in the register should be respectively treated as a half, a word, and a single precision floating point value. An index value [i] may be used to indicate the element #i stored in the vector register, with 0 being the first. Thus, $v1_h[3] is the fourth half word of register $v1, stored in bytes 6 and 7. As an example, the arrangement of the register elements of different types in the vector register type is as shown in Table 1 below:

TABLE 1

| | | | | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|---|---|---|
| BYTE | 0 | 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 | 24 | 25 | 26 | 27 | 28 | 29 | 30 | 31 |
| half | 0 | | 1 | | 2 | | 3 | | 4 | | 5 | | 6 | | 7 | | 8 | | 9 | | 10 | | 11 | | 12 | | 13 | | 14 | | 15 | |
| word | 0 | | | | 1 | | | | 2 | | | | 3 | | | | 4 | | | | 5 | | | | 6 | | | | 7 | | | |
| fp | 0 | | | | 1 | | | | 2 | | | | 3 | | | | 4 | | | | 5 | | | | 6 | | | | 7 | | | |

As shown in Table 1, word 0 may occupy the positions of byte 0 to byte 3 that overlap with the positions occupied by half word 0 and word 1 because they are placed at the positions of byte 0 to byte 1 and byte 2 to byte 3, respectively.

Two vector instructions are used to demonstrate the write-after-read (WAR) hazard:
vector negate floating-point instruction: vnegf $vdst,$vsrc,
vector convert unsigned half to word instruction: vcvtuhw $vdst,$vsrc,

Both of these two instructions read from a source vector register and write the results to a destination vector register.

The semantics of the vector negate floating point (vnegf) instruction are:

for( i = 0; i < 8; i++ )
$vdst_f [ i ] = -$vsrc_f [ i ]

The semantics for the vector convert unsigned half to word instruction (vcvtuhw) are:

for( i = 0; i < 8; i++ )
$vdst_w [ i ] = $vsrc_h[i]

The vcvtuhw instruction may have a potential problem when the destination register is the same as the source register. Consider the case of vcvtuhw $v3, $v3. In this case, the intention is to covert the first 8-half-words of $v0 into words, and then store them back in $3. However, a naïve implementation may lead to incorrect results. Consider the following simple implementation:
read a half-word
expand it
and write the results back
repeat 8 times.

To execute the instruction, the execution unit of a processor may read the half word#0 from bytes 0 and 1 of $v3. The execution unit may expand half word#0 stored at bytes 0 and 1 to a word at bytes 0, 1, 2, and 3, and write to bytes 0, 1, 2, and 3 of $v3. Next, the execution unit may read half-word#1 from bytes 2 and 3 of $v3. However, these bytes are not the original bytes at the start of the instruction. Instead, they have been overwritten by the expanded value from half-word#0. This is an example of the write-after-read hazard (also called an anti-dependence). This is just one example where a vector instruction has a potential write-after-read hazard.

One way to prevent WAR hazards from happening is to prohibit that the destination register is the same as the source register for vector instructions. Another way to prevent WAR hazards is to use simultaneous read. A microprocessor may include an instruction execution pipeline that may further divide the instruction execution into several pipeline stages including an instruction fetch stage, an instruction decode and register read stage, one or more instruction execution stages, and a register write-back stage. Further, the instruction execution pipeline does not perform sequential evaluation of data values (i.e., one element at a time) for vector instructions. Instead, the instruction execution pipeline may operate several blocks of instructions concurrently and evaluate several elements in parallel. For processors with a large number of execution blocks and moderate vector lengths, the instruction execution pipeline may read all elements of a vector simultaneously, process them simultaneously, and then write-back all the values to the registers. This kind of implementation will guarantee that all elements are read before any write operation occurs, thus avoiding WAR hazards. For example, if a processor has 8 execution blocks, the processor may execute the vcvtuhw instruction using the following sequence:
read all 8 half-words from vector register
extend
write all 8 half-words from vector register
Since all the values are read before being written, the execution of the vcvtuhw instruction may avoid the WAR hazard.

It is possible to avoid WAR hazards by rearranging certain read operations and write operations. For example, in the case of vcvtuhw instructions pipelined as described above but using only 4 execute blocks. The processor may execute vcvtuhw according to the following sequence to avoid WAR hazard:
read first 4 half-words
extend first 4 half-words, read last 4 half-words
write first 4 word, extend last 4 words
write last 4 words

Some implementations may use register renaming to avoid WAR hazard. The register renaming requires changing mappings between architected registers and physical registers. The ISA may specify a set of registers (referred to as the architected registers) that may be referenced by instructions defined by the ISA. The processor may include physical registers that can be used to support the architected registers. A program may include a vector instruction referencing one or more architected registers. During execution, the processor may allocate each of the architected registers invoked by a first vector instruction to a corresponding physical registers, thus creating first mappings between the architected registers and the physical registers. Responsive to invoking a second vector referencing one or more architected registers, the processor may update the mapping between the architected registers and the physical registers if there is a chance of unintended overwrite operation. For example, if the processor determines that a first physical register linked to a first architected register can be overwritten by the invocation of the first architected register in a second vector instruction, the processor may update the mapping of the first architected register to a second physical register to avoid the unintended result. To implement register renaming, the processor may need to include logic circuits that maintain and update the mappings between the architected registers and the physical registers. The logic circuits that maintain and update the mappings are complicated, occupy a large circuit area, and consume powers.

Different register renaming schemes may include the following steps:
every time a register is a target of an instruction, a new unused destination register is allocated for the writing of the output of the instruction and the register is mapped to that destination register.
every time a register is a source of an instruction, the last mapped destination is read to provide the input.

This means that even though the source and target architected registers specified in an instruction are the same, they are actually writing to and reading from different physical registers. A processor implementing register renaming can avoid the WAR hazard but at the cost of large circuit area and more power consumption.

Under certain situations, the above-described solutions to WAR hazards are not satisfactory. For example, backward ISA compatibility makes it impossible to forbid the source register and the destination register from being identical. The length of vectors may be larger than the number of execution blocks or the pipeline length. This leads to at least part of the results is written back before the vector is entirely read. In this situation, it is impossible to implement read before write. Register renaming requires larger circuit area and more power consumption. Thus, register renaming may be not available in low-power consumption and small-footprint processor.

To overcome the above-identified and other deficiencies, implementations of the present disclosure provide a technical solution that augments the vector register file with one or more additional buffer registers and use the buffer registers to eliminate WAR hazards. By using buffer registers, implementations of the disclosure may achieve compatibility with existing ISA, allow long vector registers, and eliminate the mapping logic circuits required by register renaming to achieve small circuit footprint and less power consumption compared to the register renaming scheme.

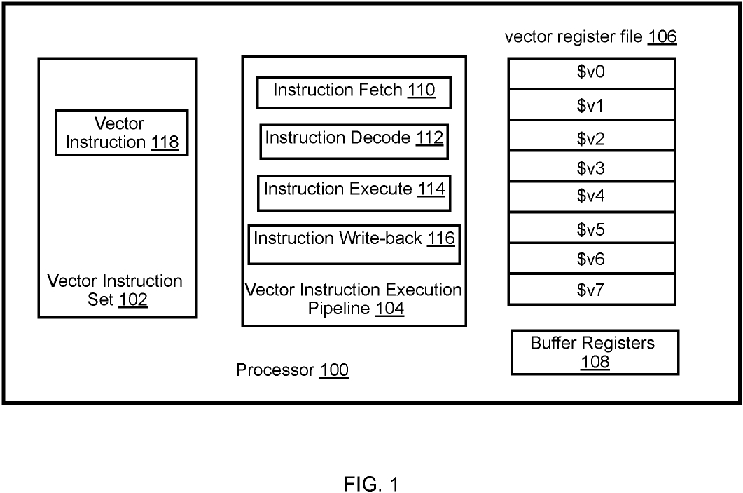

FIG. 1 illustrates a hardware processor 100 according to an implementation of the present disclosure. Processor 100 can be a central processing unit (CPU), a processing core of the CPU, a graphic processing unit (GPU), or any suitable types of processing device. As shown in FIG. 1, processor 100 may include vector instruction execution pipeline 104 and a vector register file 106. Processor 100 may include circuits implementing vector instructions 118 specified according to a vector instruction set architecture 102. The execution of a vector instruction 118 may be broken up into micro-operations (micro-ops) processed by vector instruction execution pipeline 104. In cases where the vector length is much larger than the number of execution blocks, micro-ops can be sub-vector operations that may operate on a subset of the total vectors. For example, if the number of execution blocks is eight (8) and vector length is 64, eight sub-vector operations are needed. The vector instruction execution pipeline 104 may include an instruction fetch stage 110, an instruction decode and register read stage 112, an instruction execute stage 114, and an instruction write-back stage 116. Each stage of vector instruction execution pipeline 104 may process separate micro-ops of one or more vector instructions. The execution of a later stage may depend upon the results from an earlier stage. The micro-ops may be waiting to be executed in a waiting pool stored in a memory coupled to processor 100. The instructions are moved through vector instruction execution pipeline 104 based on clock cycles. The vector instruction execution pipeline 104 may operate as follows.

At a first clock cycle, instruction fetch stage 110 may retrieve a first micro-op from the pool of micro-ops waiting to be executed.

At a second clock cycle, instruction decode stage 112 may decode the first micro-op and if needed, retrieve data values from vector registers ($v0 - $v7) of vector register file 106; instruction fetch sage 110 may retrieve a second micro-op from the pool.

At a third clock cycle, instruction execute stage 114 may execute the decoded first micro-op; instruction decode stage 112 may decode the second micro-op and if needed, retrieve data values from vector registers ($v0 - $v7) of vector register file 106; instruction fetch sage 110 may retrieve a third micro-op from the pool.

At a forth clock cycle, instruction write-back stage 116 may write the results generated by instruction execute stage 114 to one or more vector registers ($v0 -$v7) of vector register file 106; instruction execute stage 114 may execute the decoded second micro-op; instruction decode stage 112 may decode the third micro-op and if needed, retrieve data values from vector registers ($v0 - $v7) of vector register file 106; instruction fetch sage 110 may retrieve a forth micro-op from the pool. As such, vector instruction execution pipeline 104 may process micro-ops through the pipeline concurrently and efficiently.

In one implementation, processor 100 may be implemented without the mapping logic circuit for register renaming to achieve a small footprint. Instead of using the mapping logic circuit to dynamically generate and update mappings between architected registers during execution of vector instructions, each of the architected registers defined in vector instruction set 102 may be assigned to a corresponding physical register in the vector register file 106. For example, if vector instruction set 102 defines eight (8) architected vector registers, each of the architected register may be fixed assigned to a corresponding one of $v0 - $v7. To avoid the potential WAR hazards, implementations of the disclosure may include buffer registers 108. In one implementation, buffer registers 108 are extra registers in addition to vector registers ($v0 - $v7) of vector register file 106. In another implementation, buffer register 108 can be a buffer area in the memory. Unlike vector registers ($v0 - $v7), buffer registers 108 are not defined in vector instruction set 102 and therefore are not mapped to any architected registers defined in vector instruction set 102. Thus, buffer registers 108 are not identifiable by vector instructions 118. Instead, buffer registers 108 may serve as an intermediate storage that may help eliminate WAR hazards. In one implementation, instructions that are not associated with WAR hazards may be executed normally through vector instruction execution pipeline 104.

Since each of the architected registers allocated to a physical register in a one-to-one is not affected by register renaming during execution of vector instructions, the architected vector registers (e.g., $v0 - $v7) are understood also corresponding to or representing corresponding physical registers in vector register file 107 in the following description. In one implementation, vector registers associated with processor 100 may be divided into two groups. A first group of vector registers such as $v0 - $v7 in vector register file 106 are identifiable by vector instructions 118 defined in vector instruction set 102; a second group of buffer registers 108 are not mapped to any architected registers of vector instructions 118 and therefore are not identifiable by vector instructions 118 of vector instruction set 102. Instructions that are known to potentially suffer from WAR hazards may be executed in two phases. In the first phase, the instruction decode stage 112 may decode the micro-op and read from vector registers ($v0 - $v7). Subsequent to executing the micro-op by instruction execute stage 114, instruction write-back stage 116 may write the results to buffer registers 108 rather than to any one of vector registers ($v0 - $v7) identified by the micro-op as the destination register. When all micro-ops associated with execution of the instruction have completed, and the desired results are available in the buffer register, the second phase may begin. In a second phase when it is safe to write back to the destination vector register, instruction write-back stage 116 may copy the results from the buffer registers to the destination vector register.

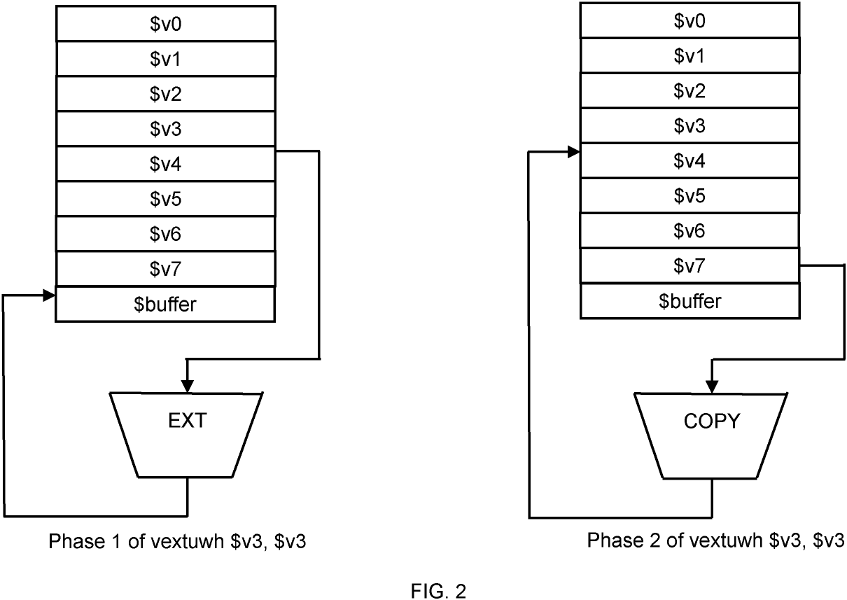

FIG. 2 illustrates an exemplary implementation of a vector instruction using buffer registers according to an implementation of the disclosure. As shown in FIG. 2, the execution of vectuwh $v3, $v3 instruction may be carried out in two phases. In phase 1, instruction execute stage 114 may execute vectuwh $v3, $v3, and instruction write-back stage 116 may write the results to a buffer register ($buffer) rather than to the identified destination register ($v3). The buffer register ($buffer) is not identified in the instruction. A logic circuit may determine that no more instruction is going to read from the destination register ($v3), and it is safe to write to the destination register in a phase 2. In the phase 2, the logic circuit may copy the data value stored in the buffer register ($buffer) to the destination register ($v3) without the risk for WAR hazards.

Using an extra register as the buffer register may help to make the performance consistent because instruction write-back stage always writes to a register and the cost to add an extra register to the register file is lower than using other storage device such as, for example, flip-flops or latches. The buffer register can either be a separate logic circuit or can be implemented as an additional register to $v0 - $v7. For example, if $v0 - $v7 are implemented using an 8-entry RAM, the RAM can be expanded to a 9-entry RAM with the buffer register as the 9^{th} entry in the RAM. In another implementation, in phase 1, instruction write-back stage 116 may write to a memory location to temporarily hold the results, and in phase 2, to copy from the results stored at the memory location to the destination register.

In another implementation, instead of writing all elements of the output to the buffer register, instruction write-back stage 116 may write a subset of elements of the output to the buffer register followed by copying the subset of elements to the destination register, while the rest of the elements are written directly to the destination register. This implementation may achieve more efficiency if, for example, the majority elements of the output vector are written over after the vector is read, and only a small subset of elements is exposed to the WAR hazard. In that case only the vector elements that are written before the last vector element is read need to be buffered; this would minimize the amount of data that needs to be copied.

In another implementation, for instructions that have a potential WAR hazard, instruction write-back stage 116 always writes the output to a buffer register, whether or not a source and destination register are the same. This has the benefit of regularizing the control for these instructions without the need to check if a source and destination are the same and handle the two cases differently.

The buffer registers may be used to implement precise interrupts. Most modern processor architectures support precise interrupts. An interrupt or exception is called precise if the saved processor state corresponds with the sequential model of program execution where one instruction execution ends before the next begins. One of the requirements of precise interrupts is that when execution of an instruction is interrupted, the state of the processor should be as though the instruction had never executed. In the context of vector instructions, this means that if processor is halted during the execution of a vector instruction, the target registers of that instruction should be unmodified.

An issue arises when the instruction being executed causes the interrupt. For instance, a floating point operation can raise a variety of IEEE floating point interrupts. In the case of a vector floating point instruction, if any one of the element wise operations causes an interrupt and if precise interrupts are supported, the implementation needs to ensure that none of the results of the vector instruction are written, including the elements that had been computed prior to the element that raised the interrupt.

To achieve the precise interrupts, implementations of the disclosure may provide an instruction that could potentially raise an interrupt to always write to a buffer register. Responsive to determining that the execution of the instruction has completed successfully, the processor may copy the results to the actual output register. If the vector instruction does have an interrupt, then the results stored in the buffer registers are discarded before an interrupt is raised. The destination register is left undisturbed to meet the requirement of a precise interrupt.

The buffering required for precise interrupts can be implemented using the circuit as shown in FIG. 2. The buffering can be done using substantially identical circuit structures as shown in FIG. 2.

In some implementations, the precise interrupt requires to write the results to the buffer registers and, if no interrupt occurs, copy the results from the buffer registers to the destination registers. This is not the most efficient approach if whether an interrupt is going to occur can be determined early on in a multi-cycle instruction. In such situations, the execution pipeline may determine whether an interrupt will occur at an early stage (e.g., the first clock cycle). For example, in a division operation, the execution pipeline may determine in the first clock cycle (prior to starting execution through the vector instruction execution pipeline) whether there will be an interrupts caused by dividing-zero exception (e.g., by checking if the divisor is or is very close to zero). In one implementation, a control logic circuit may determine, early in the execution pipeline, whether certain interrupts (such as divide-by-zero in the case of vector divides) will occur or not. Responsive to determining that no element of the output result can cause interrupts, all elements may be written back to the vector registers, thus further improving the performance of precise interrupt.

The approach of writing to a buffer and then copying when the execution of an instruction has the potential to raise an interrupt and writing directly to the vector register when the instruction cannot raise an interrupt, is particularly efficient when the processor is mostly going to run in a mode where instructions cannot raise interrupts. This no-interrupt mode may occur in the following situations:
all interrupts are disabled, allowing for all vector instructions to write directly to destination registers
a wide variety of interrupts, such as floating-point interrupts, are individually disabled, allowing for most vector instructions to write directly to the destination registers.
the processor can be set to a mode where interrupts are non-precise, in which case it is acceptable for a vector instruction to raise an interrupt with partially written targets; in this case vector instructions can write directly to the destination register.

In one implementation, whether a vector instruction can write to a destination register directly or not depends on whether there is the risk for a WAR hazard or whether the processor includes a different circuit to avoid the WAR hazard. If the processor is using the buffer register to avoid both WAR hazard and support precise interrupts, then the instruction may need to write to the buffer register even if the precise interrupts are not enabled.

In another implementation, the execution of an instruction can be carried out in two phases to improve the precise interrupt performance. In phase one, the execution of the instruction may traverse all elements to perform certain operations to determine if these operations would raise an interrupt. During phase one, the processor does not update any states (i.e., does not update the destination vector registers). Thus, the operations executed by the processor involve only read operations from the source vector registers.

If an interrupt is detected during phase one, an interrupt is raised for the instruction. If no interrupt is detected during phase one, the execution of the instruction moves to phase two. In phase two, the instruction runs through all the elements, this time computing the results and updating the states, including any destination vector registers. This would involve re-reading the source vector registers.

One advantage of this approach is that it can be applied to implement precise interrupts for any vector instruction, not just those that update registers. Consider the instruction of vector scatter store which stores the elements from a vector register a series of memory addresses. It is possible that one of these addresses is illegal, and would cause an interrupt. Any mechanism that could undo the scatter store, or buffer the scatter store till all addresses were resolved, would be computationally expensive. The two-phase approach described above, validating all addresses in the first phase and write out the results in the second phase, is more efficient. This two-phase approach is particularly useful when precise interrupts are off most of the time; if interrupts are off, only the second phase needs to be done. Precise interrupts can be used in debugging program errors because they can guarantee that the processor stops on an instruction boundary, where the state of the machine remains the same as those of all instructions prior to completing the instruction causing the interrupts while no subsequent instructions have modified the processor states. However, as discussed above, precise interrupts may add additional performance overheads. Thus, in some implementations, precise interrupt mode may be disabled to further improve processor performance. When the precise interrupt mode is disabled and when an exception occurs, the processor state will not have the guarantee of a clean boundary. For example, the instruction that causes the interrupt may have written part of the destination register.

In another implementation, this two phase-approach may be applied to memory access instructions while the buffer mechanism for vector register operations.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A processor, comprising:
a vector register file comprising a plurality of vector registers;
at least one buffer register; and
a vector processing core, communicatively connected to the vector register file and the at least one buffer register, to:
receive a vector instruction comprising a first identifier representing a first vector register of the plurality of vector registers, and a second identifier representing a second vector register of the plurality of vector registers, wherein the first vector register is a source register and the second vector register is a destination register;
execute the vector instruction based on data values stored in the first vector register to generate a result and store the result in the at least one buffer register; and
copy the result from the at least one buffer register to the second vector register.

2. The processor of claim 1, wherein the source register is one of identical to or different than the destination register.

3. The processor of claim 1, wherein the vector instruction set defines a plurality of architected registers, and wherein each of the plurality of the architected registers is mapped to a corresponding one of the plurality of vector registers.

4. The processor of claim 1, wherein each of the plurality of the architected registers is fixedly mapped to a corresponding one of the plurality of vector registers, and wherein a mapping between an architected register and a corresponding vector register is not altered by register renaming during execution of a second vector instruction.

5. The processor of claim 1, wherein execution of the vector instruction is performed in two phases comprising a first phase to generate a first result and store the first result in the at least one buffer register and a second phase to copy the result from the at least one buffer register to the second vector register.

6. The processor of claim 1, wherein the at least one buffer register is one of a location of a memory associated with the processor, a logic circuit separate from the vector register file, or an additional vector register other than the plurality of vector registers in the vector register file.

7. The processor of claim 1, wherein the processing core comprises a vector instruction execution pipeline, the vector instruction execution pipeline comprising:
an instruction fetch circuit to receive the vector instruction;
an instruction decode circuit to generate micro-ops based on the vector instruction;
an instruction execute circuit to execute the vector instruction based on data values stored in the first vector register to generate a first result and store the first result in the at least one buffer register; and
an instruction write-back circuit to copy the result from the at least one buffer register to the second vector register.

8. A processor, comprising:
a vector register file comprising a plurality of vector registers;
at least one buffer register; and
a vector processing core, communicatively connected to the vector register file and the at least one buffer register, to execute a vector instruction to:
responsive to receiving the vector instruction comprising a first identifier representing a first vector register of the plurality of vector registers and a second identifier representing a second vector register of the plurality of vector registers, and prior to performing an operation of the vector instruction, determining whether the operation of the vector instruction has an opportunity to cause a precise interrupt, wherein the first vector register is a source register and the second vector register is a destination register;
responsive to determining that performance of the operation has the opportunity to cause the precise interrupt,
execute the vector instruction based on data values stored in the first vector register to generate a result and store the result in the at least one buffer register; and
copy the result from the at least one buffer register to the second vector register.
